(19) United States
(12) Patent Application Publication
(10) Pub. No.: US 2025/0125444 A1
(43) Pub. Date: Apr. 17, 2025

(54) BATTERY CASE FOR VEHICLE

(71) Applicants: HYUNDAI MOTOR COMPANY, SEOUL (KR); KIA CORPORATION, SEOUL (KR)

(72) Inventors: Gyung Hoon Shin, Seoul (KR); Jong Gyu Park, Hwaseong-si (KR)

(21) Appl. No.: 18/602,618

(22) Filed: Mar. 12, 2024

(30) Foreign Application Priority Data
Oct. 11, 2023 (KR) 10-2023-0135207

(51) Int. Cl. H01M 10/6568; B60R 16/033; H01M 10/613; H01M 10/625; H01M 50/204; H01M 50/289

(52) U.S. Cl. CPC H01M 10/6568; B60R 16/033; H01M 10/613; H01M 10/625; H01M 50/204; H01M 50/289; H01M 2220/20

(57) ABSTRACT

In a battery case for a vehicle of the present disclosure, channels of a battery cooling block are arranged in parallel, thereby efficiently cooling a battery regardless of a position of the battery. In addition, a sealer is used to prevent a cooling medium, which is introduced into a cooling channel that exchanges heat with the battery, from being introduced into a non-cooling channel that does not exchange heat with the battery, such that the cooling medium is not introduced into the battery case, which prevents an unnecessary in weight of the battery case. In addition, a cooling block and a side member of a battery case are configured as extruded components to ensure better structural rigidity than a general battery case made by pressing, thereby allowing more cells to be installed by reducing the number of case members and penetration mounts required to ensure structural rigidity of the battery case.

### CROSS REFERENCE TO RELATED APPLICATIONS

The present application claims priority to Korean Patent Application No. 10-2023-0135207, filed on Oct. 11, 2023, the entire contents of which are incorporated herein for all purposes by this reference.

### BACKGROUND

### Field

The present disclosure relates to a battery case for a vehicle, which includes a cooling block configured to cool a battery.

### Description of the Related Art

A function of a battery case for a vehicle for cooling a battery needs to be improved to improve competitiveness and marketability of a vehicle, and energy density and integration need to be maximized by increasing a ratio of cells in the battery case. To this end, the battery case for a vehicle is required to efficiently cool the battery, many cells are required to be installed in the battery case, and a weight of the battery case is required to be reduced.

In the case of a general battery case, a battery cooling flow paths are provided as a series of flow paths, and a cooling medium flows through the series of flow paths to cool the battery. With this structure, a battery provided at a front side of the general battery case into which the cooling medium is introduced is effectively cooled, but a battery provided at a rear side cannot be effectively cooled. In addition, a flow path is provided even in a portion that does not exchange heat with the battery, and the cooling medium flows through the portion, which increases an unnecessary weight of the battery case for a vehicle.

In addition, because the case is manufactured by using a board pressed without being extruded, the case is inevitably weaker in structural rigidity than extruded components even though a shape of the case is advantageously implemented. A plurality of case members and a plurality of penetration mounts are required to compensate for an insufficient structural rigidity of the general battery case, which causes a problem in that a weight of the battery case for a vehicle increases, and energy density decreases because of a decrease in cell installation section in the battery case.

The foregoing explained as the background is intended merely to aid in the understanding of the background of the present disclosure, and is not intended to mean that the present disclosure falls within the purview of the related art that is already known to those skilled in the art.

### SUMMARY

The present disclosure is proposed to solve these problems and aims to improve a structure of a battery case, efficiently cool a battery regardless of a position of the battery in the battery case, use a sealer to prevent a cooling medium, which is introduced into a cooling channel that exchanges heat with the battery, from being introduced into a non-cooling channel of the battery case that does not exchange heat with the battery, and prevent an unnecessary increase in weight of the battery case.

The present disclosure also aims to configure a cooling block and a side member of a battery case as extruded components to ensure better structural rigidity than a general battery case made by pressing, allow more cells to be installed by reducing the number of case members and penetration mounts required to ensure structural rigidity of the battery case, and increase energy density by allowing more cells to be installed in the battery case.

Technical problems to be solved by the present disclosure are not limited to the above-mentioned technical problems, and other technical problems, which are not mentioned above, may be clearly understood from the following descriptions by those skilled in the art to which the present disclosure pertains.

In order to achieve the above-mentioned object, an embodiment of the present disclosure provides a battery case for a vehicle, the battery case including side members disposed at two opposite sides of the battery case, extending in a length direction of a vehicle, and having therein length-direction flow paths provided in the length direction of the vehicle, cooling blocks disposed between the two opposite side members, extending in a width direction of the vehicle, and having therein a plurality of channels having width-direction flow paths, the plurality of channels being continuously disposed in the length direction of the vehicle and separated by partition walls, and the width-direction flow paths connecting with the length-direction flow paths of the side members, and sealers provided at ends of the partition walls configured to separate non-cooling channels, which do not exchange heat with a battery among the plurality of channels, from cooling channels that exchanges heat with the adjacent battery, the sealers being configured to prevent a cooling medium in the adjacent cooling channels from being introduced into the non-cooling channels.

For example, the side member may be an extruded component.

For example, a plurality of connection holes may be formed in a lateral surface of the side member that faces the cooling block, and the plurality of connection holes may be formed continuously in the length direction.

For example, the connection hole may be formed in the lateral surface of the side member and provided at a point facing the cooling channel among the plurality of channels, such that the width-direction flow path of the cooling channel connects with the length-direction flow path through the connection hole, and the cooling medium does not flow through the width-direction flow path of the non-cooling channel.

For example, ends of the plurality of partition walls of the cooling blocks may adjoin lateral surfaces of the side members that face each other.

For example, the cooling block may be an extruded component.

For example, a cross member, which traverses the battery case in the width direction of the vehicle, may be coupled to the non-cooling channel among the plurality of cooling channels, and the non-cooling channel may not exchange heat with the battery.

For example, the cooling block may have an installation groove recessed inward at a point at which the partition wall, which separates the non-cooling channel and the cooling channel, is formed, and the sealer may be inserted and coupled into the installation groove.

For example, the cooling block may include an upper plate, a lower plate, and the plurality of partition walls, and the installation groove may be recessed together with the upper plate, the lower plate, and the partition walls.

For example, the sealer may include; a base; and a pair of leg portions extending from two opposite sides of the base and configured to surround the partition wall with the partition wall interposed therebetween.

For example, the base of the sealer may have one side being in close contact with the upper plate of the cooling block, and the other side being in close contact with the lower plate of the cooling block.

For example, a height of the leg portion of the sealer may be equal to a height of the partition wall of the cooling block.

For example, an outer surface of the sealer, which faces the side member, may be in close contact with the side member in a state in which the sealer is installed in a recessed groove of the cooling block, such that the non-cooling channel of the cooling block is sealed.

For example, the sealer may be made of polymer resin, and an outer surface of the sealer, which faces the side member, may be compressed by the side member when the cooling block and the side member are coupled.

The battery case according to the embodiment of the present disclosure may further include: cross members coupled to the non-cooling channels among the plurality of cooling channels and configured to traverse the battery case in the width direction of the vehicle; a longitudinal member configured to intersect the cross member while traversing the battery case in the length direction of the vehicle; and a penetration mount coupled to a vehicle body while penetrating an intersection point between the cross member and the longitudinal member in an upward/downward direction.

For example, the cross members may include: a front member configured to connect front ends of the side members disposed at two opposite sides; a rear member configured to connect rear ends of the side members; and a middle member disposed between the front member and the rear member and configured to connect the side members disposed at two opposite sides.

For example, the non-cooling channel of the cooling block may be disposed at a point positioned below the front member, the rear member, and the middle member.

The channels of the battery cooling block are arranged in parallel, thereby efficiently cooling the battery regardless of the position of the battery.

The sealer is used to prevent the cooling medium, which is introduced into the cooling channel that exchanges heat with the battery, from being introduced into the non-cooling channel in the battery case that does not exchange heat with the battery. Therefore, it is possible to prevent an unnecessary increase in weight of the battery case.

In addition, the cooling block and the side member of the battery case are configured as extruded components to ensure better structural rigidity than a general battery case made by pressing.

Therefore, it is possible to reduce the number of case members and penetration mounts required to ensure structural rigidity of the battery case, thereby allowing more cells to be installed. Therefore, it is possible to increase energy density by installing more cells in the battery case.

The effects capable of being obtained by the present disclosure are not limited to the aforementioned effects, and other effects, which are not mentioned above, will be clearly understood by those skilled in the art from the following description.

### BRIEF DESCRIPTION OF THE FIGURES

FIG. 1 is a view illustrating a battery case for a vehicle according to an embodiment of the present disclosure.

FIG. 2 is a front view of a sealer according to the embodiment of the present disclosure.

FIG. 3 is a perspective view of the sealer according to the embodiment of the present disclosure.

FIG. 4 is a view illustrating an end of a partition wall that separates a cooling channel and a non-cooling channel of a cooling block according to the embodiment of the present disclosure.

FIG. 5 is a view illustrating a state in which the sealer according to the embodiment of the present disclosure is installed at the end of the partition wall that separates the cooling channel and the non-cooling channel of the cooling block.

FIG. 6 is a view illustrating a state in which a cooling medium flows in the battery case for a vehicle according to the embodiment of the present disclosure.

FIG. 7 is a view illustrating the side member that a plurality of connection holes are continuously formed on.

### DETAILED DESCRIPTION

An object of the present disclosure is to efficiently cool a battery regardless of a position of the battery by arranging channels of a battery cooling block in parallel. In addition, an object of the present disclosure is to use a sealer to prevent a cooling medium, which is introduced into a cooling channel that exchanges heat with the battery, from being introduced into a non-cooling channel that does not exchange heat with the battery, such that the cooling medium is not introduced into the non-cooling channel, which prevents an unnecessary in weight of the battery case.

In addition, an object of the present disclosure is to configure a cooling block and a side member of the battery case as extruded components to ensure better structural rigidity than a general battery case made by press-bonding. This structure reduces the number of case members and penetration mounts required to ensure structural rigidity of the battery case, thereby allowing more cells to be installed by utilizing a residual space. The present disclosure relates to a battery case for a vehicle, which is capable of increasing energy density by allowing more cells to be installed in the battery case.

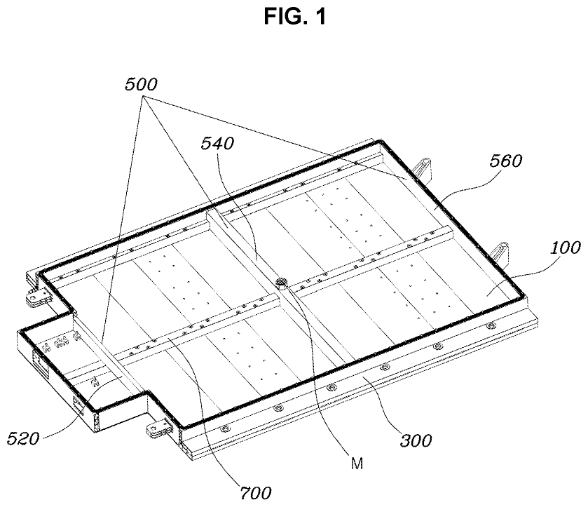

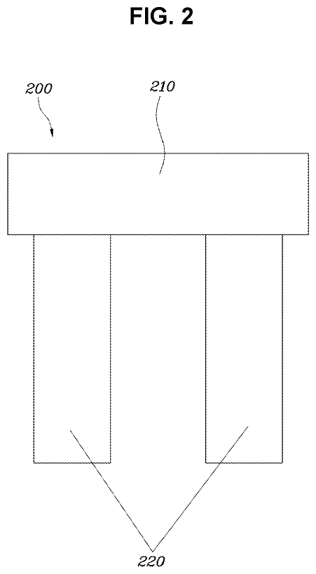

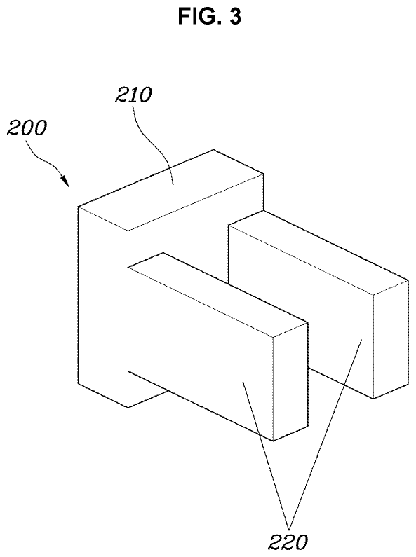

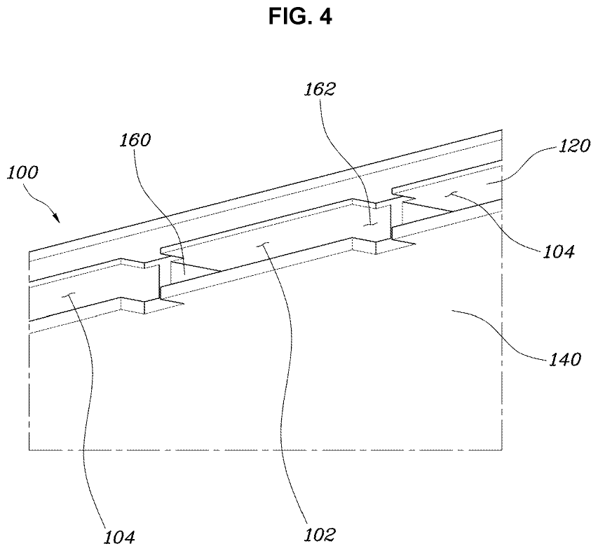

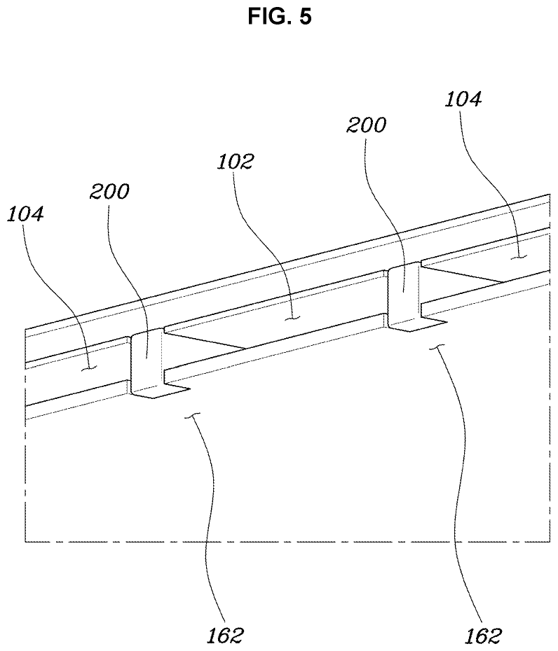

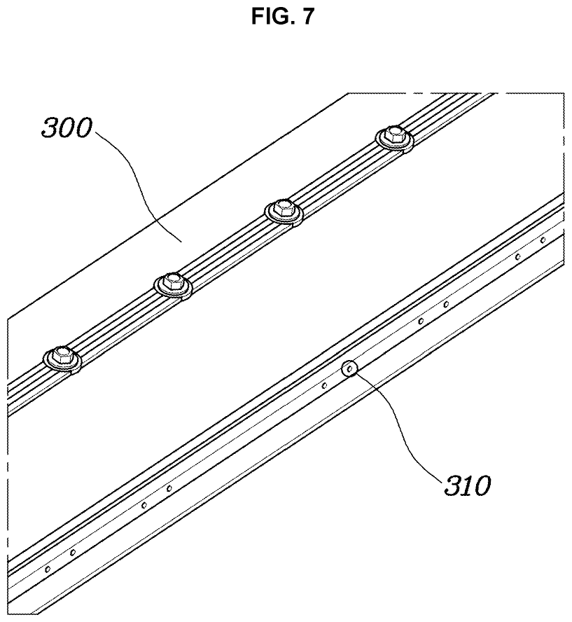

FIG. 1 is a view illustrating a battery case for a vehicle according to an embodiment of the present disclosure. FIG. 2 is a front view of a sealer according to the embodiment of the present disclosure, and FIG. 3 is a perspective view of the sealer according to the embodiment of the present disclosure. FIG. 4 is a view illustrating an end of a partition wall that separates a cooling channel and a non-cooling channel of a cooling block according to the embodiment of the present disclosure, and FIG. 5 is a view illustrating a state in which the sealer according to the embodiment of the present disclosure is installed at the end of the partition wall that separates the cooling channel and the non-cooling channel of the cooling block. FIG. 7 is a view illustrating the side member that a plurality of connection holes are continuously formed on

First, the battery case for a vehicle according to the embodiment of the present disclosure will be described with reference to FIGS. 1, 4, 5, 7.

The battery case for a vehicle according to the embodiment of the present disclosure includes side members 300 disposed at two opposite sides of the battery case, extending in a length direction of a vehicle, and having therein length-direction flow paths provided in the length direction of the vehicle, cooling blocks 100 disposed between the two opposite side members 300, extending in a width direction of the vehicle, and having therein a plurality of channels having width-direction flow paths, the plurality of channels being continuously disposed in the length direction of the vehicle and connecting with the length-direction flow paths of the side members, sealers 200 configured to divide the plurality of channels into non-cooling channels 102 that do not exchange heat with a battery, and cooling channels 104 that exchange heat with the adjacent battery, and cross members 500 configured to connect the two opposite side members traversing the battery case in the width direction of the vehicle.

The battery case for a vehicle according to the embodiment of the present disclosure will be described with reference to FIG. 1.

The battery case for a vehicle according to the embodiment of the present disclosure has a lattice structure in which the side members 300 and the cooling blocks 100, which are configured as extruded components, intersect perpendicularly.

The side member 300 includes a support body and a length-direction flow path through which a cooling medium flows. The side member is also made by extrusion, and an internal structure of the side member is divided by a partition wall or the like into a flow path and a support body member, such that necessary rigidity may be ensured, and the amount of flowing cooling medium may be reduced, which may reduce a decrease in weight.

Meanwhile, the cooling block 100 defines the width-direction flow path through which the cooling medium flows. The cooling medium introduced through one side member is separated and introduced into the channels of the cooling block, the cooling medium flows through the channels of the cooling block, and then the cooling medium is collected in the other side member and discharged, such that the plurality of channels constitutes parallel flow paths. In addition, the cooling blocks define a flat plate shape as the plurality of channels is continuously disposed in a transverse direction. Further, the cross members 500 traverse on the cooling blocks in the width direction of the vehicle. The cross members include a front member 520 connected to front sides of the two opposite side member 300, a rear member 560 connected to rear sides of the two opposite side member 300, a middle member 540 positioned between the front member and the rear member and disposed at a center of the battery case for a vehicle. In addition, a transverse member 700 is disposed at the center of the battery case for a vehicle and extends in the length direction of the vehicle while intersecting the cross members. Further, a penetration mount is installed at a point M at which the middle member 540 and the transverse member 700 intersect. Therefore, the basic rigidity of the case is implemented by the extrusion structure, and the connection with a vehicle body is implemented only at one center point, which saves a space for fastening. Further, one fastening point is disposed at the point at which the cross member and the transverse member intersect, such that the rigidity may be effectively ensured, and the impact may be efficiently transmitted.

In the related art, cooling flow paths of a battery case are configured in series. In this structure, a channel for cooling a battery is connected to one continuous line without diverging into a plurality of channels. In this structure, a battery positioned at a front side of the battery case for a vehicle, into which the cooling medium is introduced, is effectively cooled while exchanging heat with a low-temperature cooling medium that does not exchange heat with another battery, but a battery positioned at a rear side is not effectively cooled because this battery exchanges heat with a cooling medium having a temperature already raised while cooling the battery at the front side. For this reason, there is a problem in that cells are not thermally balanced.

However, according to the embodiment of the present disclosure, the cooling flow paths for the battery constitute the parallel structure. With this structure, even the battery positioned at the rear side of the battery case for a vehicle may exchange heat with the low-temperature cooling medium that does not exchange heat with another battery. That is, because the heat exchange is performed by the cooling medium having the same temperature in the length direction of the vehicle, the thermal balancing may be maintained in the length direction of the vehicle. In addition, the channel extends in the width direction of the vehicle, and a flow path of the channel is remarkably shorter than a length of the vehicle, such that a temperature difference between the cooling media is small in the width direction of the vehicle, thereby easily implementing thermal balancing. Further, additionally, the extrusion-type cooling block has a flat shape, such that a heat exchange area with the battery increases, thereby effectively performing the heat exchange with the battery.

Because a battery case in the related art is manufactured by welding a pressed board made by pressing instead of extrusion, the battery case is inevitably weaker in structural rigidity than extruded components even though a shape of the battery case is advantageously implemented. For this reason, a plurality of case members and a plurality of penetration mounts are used for the battery case in the related art to reinforce the structural rigidity, which causes a problem of an increase in weight of the battery case.

However, according to the embodiment of the present disclosure, the battery case is configured as an extruded component and coupled in the form of a lattice, which may increase basic rigidity, and remarkably reduce the number of case members and penetration mounts required to ensure the structural durability in comparison with the related art. Specifically, as illustrated in FIG. 1, the battery case for a vehicle according to the embodiment of the present disclosure may ensure the structural durability required for the battery case by means of the middle member 540, the transverse member 560, and the penetration mount M disposed at only one point, thereby reducing the weight of the battery case. In addition, a battery cell installation space is ensured in the battery case for a vehicle to a degree to which the number of case members decreases. Therefore, more batteries may be installed, which may increase energy density.

The side member of the present disclosure has a structure including the structure support body and the length-direction flow path through which the cooling medium flows. The cooling medium flows only through the length-direction flow path without flowing through the structure support body. This structure may improve the structural durability of the battery case and protect the cooling flow path in the side member. Further, this structure may remarkably reduce the amount of flowing cooling medium, which is very advantageous even in terms of weight.

The sealer and the cooling block according to the embodiment of the present disclosure will be described with reference to FIGS. 1, 2, 3, 4, and 5.

The cooling block 100 includes a plurality of channels, and the plurality of channels includes the cooling channel 104 installed below a space, in which the battery is installed, and configured to exchange heat with the battery, and the non-cooling channel 102 positioned below the front member 520, the middle member 540, and the rear member 560 and configured not to exchange heat with the battery.

A plurality of connection holes 310 is continuously formed in a lateral surface of the side member 300 that faces the cooling block 100. In this case, the plurality of connection holes 310 is formed in the lateral surface adjoining the cooling channel 104, such that the side member and the cooling channel connect with each other. Further, no connection hole 310 is formed in a lateral surface adjoining the non-cooling channel 102, such that the side member and the cooling channel do not connect with each other.

The cooling channel and the non-cooling channel, which are adjacent to each other, are separated by a partition wall 160. An installation groove 162 is formed at an end of the partition wall as an upper plate 120, a lower plate 140, and the partition wall 160 of the cooling block are recessed together.

The sealer includes a pair of leg portions 220 configured to surround the partition wall of the cooling block with the partition wall interposed therebetween, the leg portion having the same height as the partition wall, and a base 210 having a higher height than the leg portion and configured to be in close contact with the upper plate and the lower plate of the partition wall. In addition, the sealer is made of polymer resin.

In case that the cooling medium flows through the portion that does not exchange heat with the battery, the weight of the battery case unnecessarily increases because of an unnecessary increase in amount of the cooling medium.

However, according to the present disclosure, the cooling medium is introduced only into the cooling channel 104 that exchanges heat with the battery, such that the function of the heat exchange with the battery may be maintained. Further, because the cooling medium is not introduced into the non-cooling channel 102 that does not exchange heat with the battery, it is possible to prevent an unnecessary increase in weight of the battery case.

In addition, in case that the cooling block is generally configured as an extruded component, an end of the cooling block may not be uniform. In this case, the cooling medium may finely leak from the end of the non-uniform channel, and thus the cooling medium flowing through the cooling channel 104 may leak to the non-cooling channel 102. For this reason, the cooling medium stays in an unnecessary zone, which causes an unnecessary increase in weight of the battery case.

However, according to the present disclosure, the non-cooling channel 102 and the cooling channel 104, which is adjacent to the non-cooling channel 102, are blocked from each other by the sealer 200 installed in the installation groove 162, such that the cooling medium flowing through the cooling channel does not flow to the non-cooling channel. Therefore, it is possible to prevent an unnecessary in weight of the battery case by solving the problem in that the cooling medium stays in the unnecessary zone.

In addition, the base 210 of the sealer 200 is installed in the installation groove 162 so as to be in close contact with the upper and lower plates of the partition wall. This structure may effectively block and seal the non-cooling channel from the adjacent cooling channel.

A height of the leg portion 220 of the scaler 200 is equal to a height of the partition wall of the cooling block. With this structure, the upper and lower ends of the leg portion are also provided in the installation groove and in close contact with the upper and lower plates of the cooling block while surrounding the partition wall, thereby effectively blocking and scaling the non-cooling channel from the adjacent cooling channel. Therefore, the sealer implements perfect sealing inside and outside the installation groove while surrounding the partition wall.

The sealer 200 may be made of various materials and made of polymer resin. In this case, when the side member 300 and the cooling block 100 are in close contact with each other, the sealer may be compressed while effectively coming into close contact with the side member in comparison with a sealer made of a non-polymer material. This structure may effectively block and seal the non-cooling channel from the adjacent cooling channel.

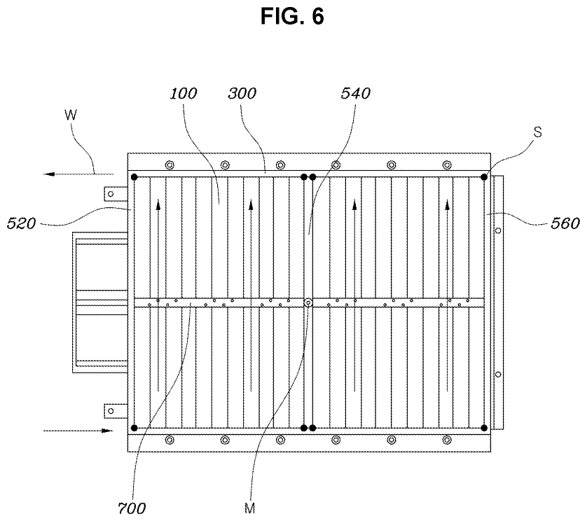

A process related to a flow of the cooling medium in the battery case for a vehicle according to the embodiment of the present disclosure will be specifically described with reference to FIG. 6.

When the cooling medium is introduced (W) through the front side of one of the two opposite side members 300, the cooling medium flows through the flow path formed in the length direction in the side member 300. The cooling medium is introduced into the cooling block 100 through the connection hole 310 formed in the lateral surface adjoining the cooling channel, and the cooling medium flows through the cooling channel 104 formed in the width direction of the vehicle, thereby cooling the battery installed in the installation space. The cooling medium flowing through the cooling channel 104 is introduced into the length-direction flow path in the side member 300 through the connection hole 310 formed in the lateral surface of the other side member 300 adjoining the cooling block 100, and the cooling medium is discharged through the front side of the other side member 300.

In this case, the sealers 200 are installed at distal end points S of the partition walls 160 adjacent to the cooling channels 104 and the non-cooling channels 102 and block and seal the non-cooling channels 102 from the cooling channels 104. Therefore, the introduction of the cooling medium into the non-cooling channel 102 is prevented. This structure prevents the cooling medium from flowing through or staying in the non-cooling channel, thereby preventing an unnecessary increase in weight of the battery case.

It should be appreciated that the detailed description is interpreted as being illustrative in every sense, not restrictive. The scope of the present disclosure should be determined based on the reasonable interpretation of the appended claims, and all of the modifications within the equivalent scope of the present disclosure belong to the scope of the present disclosure.

1. A battery case for a vehicle, the battery case comprising:
a first side member positioned at a first side of the battery case, and a second side member positioned on an opposite second side of the battery case, extending in a length direction of a vehicle, and having length-direction flow paths provided in the length direction of the vehicle;
a plurality of cooling blocks positioned between the first and second side members, extending in a width direction of the vehicle, and having a plurality of channels having width-direction flow paths, the plurality of channels being continuously disposed in the length direction of the vehicle and separated by partition walls, and the width-direction flow paths connecting with the length-direction flow paths of the first and second side members; and
a plurality of sealers provided at ends of the partition walls, the plurality of sealers configured to separate non-cooling channels, which do not exchange heat with a battery among the plurality of channels, from cooling channels that exchanges heat with the adjacent battery, the plurality of sealers being configured to prevent a cooling medium in the adjacent cooling channels from being introduced into the non-cooling channels.

2. The battery case of claim 1, wherein each of the first and second side members is an extruded component.

3. The battery case of claim 1, wherein a plurality of connection holes are formed in a lateral surface of each of the first and second side members that faces the plurality of cooling blocks, and the plurality of connection holes are formed continuously in the length direction.

4. The battery case of claim 3, wherein each of the plurality of connection holes is formed in the lateral surface of each of the first and second side members and positioned at a point facing the cooling channel among the plurality of channels, such that the width-direction flow path of the cooling channel connects with the length-direction flow path through the connection hole, and the cooling medium does not flow through the width-direction flow path of the non-cooling channel.

5. The battery case of claim 1, wherein ends of the plurality of partition walls of the cooling blocks adjoin lateral surfaces of the side members that face each other.

6. The battery case of claim 1, wherein the plurality of cooling blocks are extruded components.

7. The battery case of claim 1, wherein a cross member, which traverses the battery case in the width direction of the vehicle, is coupled to the non-cooling channel among the plurality of cooling channels, and the non-cooling channel does not exchange heat with the battery.

8. The battery case of claim 1, wherein each of the plurality of cooling blocks has an installation groove recessed inward at a point at which the partition wall, which separates the non-cooling channel and the cooling channel, is formed, and one of the plurality of sealers is inserted and coupled into each of the installation grooves.

9. The battery case of claim 8, wherein each of the plurality of cooling blocks comprises an upper plate, a lower plate, and the plurality of partition walls, and the installation groove is recessed together with the upper plate, the lower plate, and the partition walls.

10. The battery case of claim 8, wherein each of the plurality of sealers comprises:
a base; and
a pair of leg portions extending from two opposite sides of the base, and configured to surround the partition wall with the partition wall interposed therebetween.

11. The battery case of claim 9, wherein the base of each of the plurality of sealers has one side being in contact with the upper plate of the cooling block, and an other side being in contact with the lower plate of each of the plurality of cooling blocks.

12. The battery case of claim 9, wherein a height of the leg portion of each of the plurality of sealers is equal to a height of the partition wall of each of the plurality of cooling blocks.

13. The battery case of claim 8, wherein an outer surface of each of the plurality of sealers, which faces the first or second side member, is in contact with the side member in a state in which the sealer is installed in a recessed groove of the cooling block, such that the non-cooling channel of the cooling block is sealed.

14. The battery case of claim 8, wherein each of the plurality of sealers is made of polymer resin, and an outer surface of each of the plurality of sealers, which faces the first or second side member, is compressed by the side member when the cooling block and the side member are coupled.

15. The battery case of claim 1, further comprising:
cross members coupled to the non-cooling channels among the plurality of cooling channels and configured to traverse the battery case in the width direction of the vehicle;
a longitudinal member configured to intersect the cross member while traversing the battery case in the length direction of the vehicle; and
a penetration mount coupled to a vehicle body while penetrating an intersection point between the cross member and the longitudinal member in a vertical direction.

16. The battery case of claim 15, wherein the cross members comprise:
a front member configured to connect front ends of the first and second side members;
a rear member configured to connect rear ends of the first and second side members; and
a middle member disposed between the front member and the rear member and configured to connect the first and second side members.

17. The battery case of claim 16, wherein the non-cooling channel of each of the plurality of cooling blocks is disposed at a point positioned below the front member, the rear member, and the middle member.
